(19) United States
(12) Patent Application Publication
(10) Pub. No.: US 2026/0119394 A1
(43) Pub. Date: Apr. 30, 2026

(54) MEMORY SYSTEMS AND TECHNIQUES WITH SUPPORT FOR SPARSE NEURAL NETWORK COMPUTATIONS

(71) Applicant: Rambus Inc., San Jose, CA (US)

(72) Inventor: Steven C. Woo, Saratoga, CA (US)

(21) Appl. No.: 19/366,910

(22) Filed: Oct. 23, 2025

Related U.S. Application Data
(60) Provisional application No. 63/714,431, filed on Oct. 31, 2024.

(51) Int. Cl. G06F 12/02

(52) U.S. Cl. CPC G06F 12/0292; G06F 2212/1024

(57) ABSTRACT

Aspects and implementations include systems and techniques that implement efficient indexing and access to sparse neural network parameters. In one example, a memory system includes a buffer chip communicatively coupled to the one or more memory units. The buffer chip is to obtain a first index associated with positions of a plurality of elements of a sparse matrix (SM) along a first dimension of the SM and obtain a second index associated with positions of the plurality of the elements of the SM along a second dimension of the SM. The buffer chip is further to obtain, using the first index and the second index, memory addresses of the plurality of the elements of the SM stored in the one or more memory units, and retrieve, based on the memory addresses, the plurality of the elements of the SM from the one or more memory units.

### CLAIM OF PRIORITY

The present application claims the benefit under 35 U.S.C. § 119 (e) of U.S. Provisional Patent Application No. 63/714,431 filed Oct. 31, 2024, entitled “MEMORY SYSTEMS AND TECHNIQUES WITH SUPPORT FOR SPARSE NEURAL NETWORK COMPUTATIONS,” the entire contents of which are incorporated in their entirety by reference herein.

### TECHNICAL FIELD

The disclosure pertains to computing applications, more specifically to systems and techniques that improve efficiency of memory utilization and increase speed of computations including computations associated with large artificial intelligence (AI) models.

### BRIEF DESCRIPTION OF THE DRAWINGS

The present disclosure will be understood more fully from the detailed description given below and from the accompanying drawings of various implementations of the disclosure.

FIGS. 1A-1C illustrates an efficient scheme of indexing and dereferencing of sparse neural network parameters in memory retrieval and storage operations, in accordance with some aspects of the present disclosure.

FIG. 2 is a block diagram illustrating an example computing device in which implementations of the present disclosure may operate.

FIG. 3 illustrates an architecture of a memory module having sparse neural network support, in accordance with some aspects of the present disclosure.

FIG. 4 illustrates an example architecture of a buffer chip capable of supporting indexing, dereferencing, and accessing parameters of sparse neural networks, in accordance with some aspects of the present disclosure.

FIG. 5A illustrates an example data flow implemented by the buffer chip of FIG. 4 as part of a forward pass of a sparse neural network, in accordance with some aspects of the present disclosure.

FIG. 5B illustrates an example data flow implemented by the buffer chip of FIG. 4 as part of a backward pass of a sparse neural network, in accordance with some aspects of the present disclosure.

FIG. 6 illustrates another example architecture of a buffer chip capable of supporting indexing, dereferencing, and accessing parameters of sparse neural networks, in accordance with some aspects of the present disclosure.

FIGS. 7A-7B illustrate schematically possible formats of data bursts delivered from the memory system to the host, in accordance with some aspects of the present disclosure.

FIGS. 8A-8B illustrate an example architecture of a memory controller deployed as part of a buffer chip that supports indexing, dereferencing, and accessing parameters of sparse neural networks, in accordance with some aspects of the present disclosure.

FIG. 9 illustrates an example architecture of a combined buffer chip capable of supporting indexing, dereferencing, and accessing parameters of sparse neural networks, in accordance with some aspects of the present disclosure.

FIGS. 10A-10B illustrate an example architecture of a high bandwidth (HBM) memory system capable of supporting indexing, dereferencing, and accessing parameters of sparse neural networks, in accordance with some aspects of the present disclosure.

FIG. 11 is a flow diagram illustrating an example method of retrieving elements of sparse matrices stored in a memory module, in accordance with some aspects of the present disclosure.

FIG. 12 depicts a block diagram of an example computer system capable of deploying systems and techniques in accordance with some aspects of the present disclosure.

### DETAILED DESCRIPTION

Aspects and implementations of the present disclosure are related to memory systems and techniques that efficiently store and retrieve elements of sparse matrices, including but not limited to parameters of neural networks. More specifically, some aspects of the present disclosure are directed to efficient storage and retrieval of elements of weight matrices of parameters (e.g., weights and biases) of neural networks in both forward-pass and backward-pass neural computations.

An artificial neural network (NN) is a collection of computational operations that emulate how a biological NN operates and that may be used in a variety of applications, such as object and pattern recognition, voice recognition, text recognition, robotics, decision making, game playing, behavior modeling, speech recognition, text and speech generation, and numerous other tasks. A NN often may be mapped as a graph that includes a collection of nodes and edges, where computations are performed within nodes and the data (inputs and outputs of the nodes) flows along various edges connecting the nodes. Nodes may be arranged in layers, with an input layer receiving input data (e.g., a digital representation of an image) and an output layer delivering an output (e.g., image classification) of the NN. Depending on a domain-specific problem solved by the NN, any number of hidden layers may be positioned between the input layer and the output layer. Various NN architectures may include feed-forward NNs, recurrent NNs, convolutional NNs, long/short term memory NNs, Boltzmann machines, Hopfield NNs, Markov NNs, NNs with attention transformer NNs, and many other types of NNs.

A node of a NN may receive multiple input values {xᵢ} generated by other nodes (e.g., nodes of upstream layers) or provided as external inputs into the NN, e.g. by an image capturing or rendering device. The node may be associated with a respective plurality of weights {wᵢ} that weigh the input values and may further include a bias value b, to compute an output y of the node: Σⱼxⱼ·wⱼ+b=y. Similarly, a whole layer, e.g., layer L+1, of nodes may compute its output values yₖ as a matrix multiplication, Σⱼxⱼ·wⱼₖ+bₖ=yₖ, of a vector of outputs xⱼ of the previous layer L, using the matrix of weights wⱼₖ and, possibly, a vector of biases bₖ whose values are determined in training of the NN.

As NNs become more sophisticated and capable of solving an increasing number of tasks, the complexity of NNs is growing exponentially. In particular, a number of nodes and the size of the weight matrices in state-of-the-art NNs increases by about ten times each year. Accordingly, new NNs require enormous memory resources, e.g., thousands or even more processing units (such as graphics processing units or GPUs) are often used to train and/or deploy modern NNs. One technique to manage the size of NN inputs is to train the NN such that the matrices wⱼₖ (for various layers) are sparse, e.g., have 20%, 10%, 5%, 1%, etc., of non-zero parameters. For example, after a NN is trained, pruning techniques can be used to identify neural nodes that have little effect on the NN outputs and setting parameters (weights and biases) of those nodes to zero. Other techniques include forcing the NNs to learn sparse parameters wⱼₖ and bₖ already during the initial training. Sparse matrices of the NN parameters can be stored using reduced memory resources provided that positions of non-zero parameters, e.g., weights and biases, are suitably indexed and referenced.

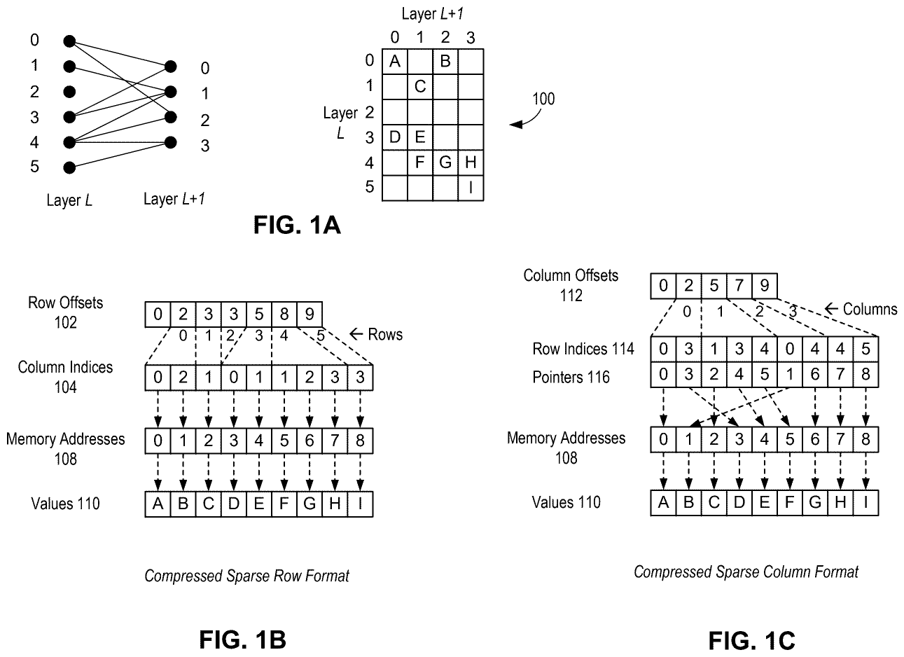

FIGS. 1A-1C illustrates an efficient scheme of indexing and dereferencing of sparse neural network parameters in memory retrieval and storage operations, in accordance with some aspects of the present disclosure. FIG. 1A illustrates a portion of a sparse matrix 100 corresponding to neural connections between nodes of two consecutive layers of a NN. Cells of sparse matrix 100 indicated with letters have corresponding non-zero weights A . . . I while empty cells have zero weights or small weights that are being approximated with zeros, culled, ignored, and/or otherwise not being used. Element wⱼₖ of sparse matrix 100 correspond to a weight of a neural connection between node j of layer L and node k of layer L+1. For example, w₀₀=A corresponds to a weight of neural connection between node 0 of layer L and node 0 of layer L+1, weight w₀₂=B corresponds to a weight of neural connection between node 0 of layer L and node 2 of layer L+1, weight w₄₁=F corresponds to a weight of neural connection between node 4 of layer L and node 1 of layer L+1, and so on. Although the discussion herein may reference weights wⱼₖ, it should be understood that similar techniques may also be used to store non-zero bias values bₖ. For example, a vector of biases {bₖ} may be stored as an additional row of the weight matrix. The techniques disclosed herein allow a memory device to store the non-zero matrix elements and to save memory resources by not storing zero elements.

FIG. 1B illustrates a compressed sparse row format that represents a sparse matrix 100 of FIG. 1A. Compressed sparse row format may include row offsets 102 and column indices 104 to identify non-zero elements of sparse matrix 100 and the corresponding memory addresses 108 in a suitable memory device where (non-zero) values 110 are stored. As illustrated, column indices 104 sequentially enumerate columns of non-zero elements wⱼₖ, starting with elements of the top row j=0, and continuing with other rows, j=1, j=2, and so on. Row offsets 102 indicate how many non-zero elements wⱼₖ are in each row, given by the difference of RowOffset[⋅] values in consecutive cells. More specifically, the number of non-zero elements NumberElements[j] in row j is given by the difference:

$$NumberElements [ j ] = RowOffset [ j + 1 ] - RowOffset [ j ] .$$

For example, the number of non-zero elements in row 0 is RowOffset[1]−RowOffset[0]=2−0=2, the number of non-zero elements in row 1 is RowOffset[2]−RowOffset[1]=3−2=1, and so on. Dashed lines and numbers between row offsets 102 and column indices 104 in FIG. 1B illustrate identification of non-zero elements in each row of sparse matrix 100.

Memory addresses 108 may be associated with corresponding cells in column indices 104. Although memory addresses 108 are indicated with consecutive numbers 0, 1, 2 . . . for simplicity, any other suitable set of ordered addresses may be used instead. Memory addresses 108 may point to specific locations in the memory device where corresponding values 110, e.g., A, B, C, . . . are stored.

During a forward pass through the NN (typically encountered as part of processing of training data and inference processing of new data), computations of the output values Σⱼxⱼ·wⱼₖ+bₖ=yₖ may be performed in the natural order defined by column indices 104 (which may also be the order of memory addresses 108) with the correct positions jk determined by row offsets 102 and column indices 104, e.g., starting with elements of the top row j=0 (traversed left-to-right), and similarly continuing with other rows, j=1, j=2, etc.

During a backward pass through the NN (typically used in training of the NN), a processing device has to retrieve the matrix elements in a different order, e.g., starting with elements of the left column k=0 (traversed top-to-bottom), and similarly continuing with other columns, k=1, k=2, and so on. The compressed sparse row format of FIG. 1B then does not immediately indicate positions of non-zero elements within individual columns.

FIG. 1C illustrates a compressed sparse column format that may be used for representing sparse matrix 100 of FIG. 1A. Compressed sparse column format may include row indices 114 that sequentially enumerate columns of non-zero elements wⱼₖ, starting with elements of the left column k=0, and continuing with other columns, k=1, k=2, and so on. Column offsets 112 indicate how many non-zero weights are within each column, given by the difference of ColumnOffset[⋅] values in consecutive cells of column offsets 112. More specifically, the number of non-zero elements NumberElements[k] in column k is given by the difference:

$$NumberElements [ k ] = ColumnOffset [ k + 1 ] - C o l umnOffse t [ k ] .$$

For example, the number of non-zero elements in column 0 is ColumnOffset[1]−ColumnOffset[0]=2−0=2, the number of non-zero weights in column 1 is ColumnOffset[2]−ColumnOffset[1]=3−0=3, and so on. Dashed lines and numbers between column offsets 112 and row indices 114 in FIG. 1C illustrate identification of non-zero weights in each row of weight matrix 100.

In the memory referencing scheme that is based on correspondence of column indices 104 to consecutive memory addresses 108, these memory addresses do not correspond to consecutive row indices 114. For example, the second cell (identifying row 3) in row indices 114 corresponds to the matrix element w₃₀ (value D) whereas the sixth cell (identifying row 0) in row indices 114 corresponds to the matrix element w₀₂ (value B). As a result, an additional referencing of row indices 114 to memory addresses 108 may be implemented for the compressed sparse row format using pointers 116. A pointer P[k] may indicate a specific memory address 108 associated with k-th cell of row index 114. For example, as illustrated, pointer P[0]=0 may be pointing to memory address 0 storing weight A, pointer P[1]=3 may be pointing to memory address 3 storing weight D, pointer P[3]=4 may be pointing to memory address 4 storing weight E, and so on.

The compressed sparse row format may be used for forward passes through NNs while the compressed sparse column format may be used for backward passes (or vice versa, in some implementations). For example, during a backward pass, a processing device may perform computations/memory accesses in the order defined by row indices 114 while identifying correct memory addresses 108 using pointers 116. The correct positions jk of non-zero elements wⱼₖ may be determined by a combination of column offsets 112 and row indices 114, e.g., starting with elements of the left column k=0 (traversed top-to-bottom), and similarly continuing with other columns, k=1, k=2, etc.

In some implementations, retrieval and/or storage of sparse NN parameters may be performed using a memory module having one or more storage units (e.g., DRAM units) and a buffer chip capable of supporting indexing, dereferencing, and access to NN parameters in the storage unit(s). In some implementations, the buffer chip may store row offsets 102 and/or column offsets 112 in its internal cache for fast retrieval since the size of the row/column offset arrays is often relatively small.

During forward pass computations, the buffer chip may receive an instruction (e.g., from a host processing device, such as a CPU, GPU, etc.) to retrieve weights of the neural edges connecting neurons of layer L with neurons of layer L+1 of a specific NN being executed. The buffer chip may retrieve, from its internal cache, row offsets 102 associated with different rows of the sparse matrix of various edge connections between nodes of layer L and nodes of layer L+1. The buffer chip may then compute differences between different values of row offsets 102 indicating the number of non-zero elements within consecutive rows of the sparse matrix. The buffer chip may then fetch, from a storage unit (e.g., a DRAM unit), column indices 104 and memory addresses 108 that have been correctly apportioned between different rows of the sparse matrix using the computed differences of row offsets 102, identifying correct pairs of indices jk of non-zero matrix elements wⱼₖ of each row. The storage unit may send the requested column indices 104 and memory addresses 108 to a data buffer. The buffer chip may then request, from the storage unit (or some other storage unit) values 110 stored in association with the provided memory addresses 108. The values 110 may also be stored in the data buffer (together with the correct pairs of indices jk) prior to being delivered to the host processor. In some implementations, rather than making two consecutive requests for memory addresses 108 and values 110, the buffer chip may make a single request for the column indices 104 and the storage unit may identify and fetch memory addresses 108 automatically (e.g., using unit's logic circuitry) without further prompting and place the values 110 into the data buffer, which then delivers its content (non-zero values wⱼₖ indexed by pairs jk) to the host processing unit.

During backward pass computations, the buffer chip may receive an instruction from the host processing device to retrieve weights of the neural edges connecting neurons of layer L+1 with neurons of layer L of the NN being executed. The buffer chip may retrieve, from its internal cache, column offsets 112 associated with different columns of the sparse matrix of various edge connections between nodes of layer L+1 and nodes of layer L. The buffer chip may then compute differences between different values of column offsets 112 indicating the number of non-zero elements within consecutive columns of the sparse matrix. The buffer chip may then fetch, from the storage unit, row indices 114 and respective pointers 116 to memory addresses 108. The storage unit may access and dereference pointers 116 sequentially, e.g., in the order of row indices 114. For example, dereferencing may include replacing pointer values with memory addresses 108 referenced by the respective pointers 116 and fetching values 110 identified by these memory addresses 108. The retrieved row indices 114 and values 110 may be placed in a data buffer together with pairs jk prior to being delivered to the host processing unit.

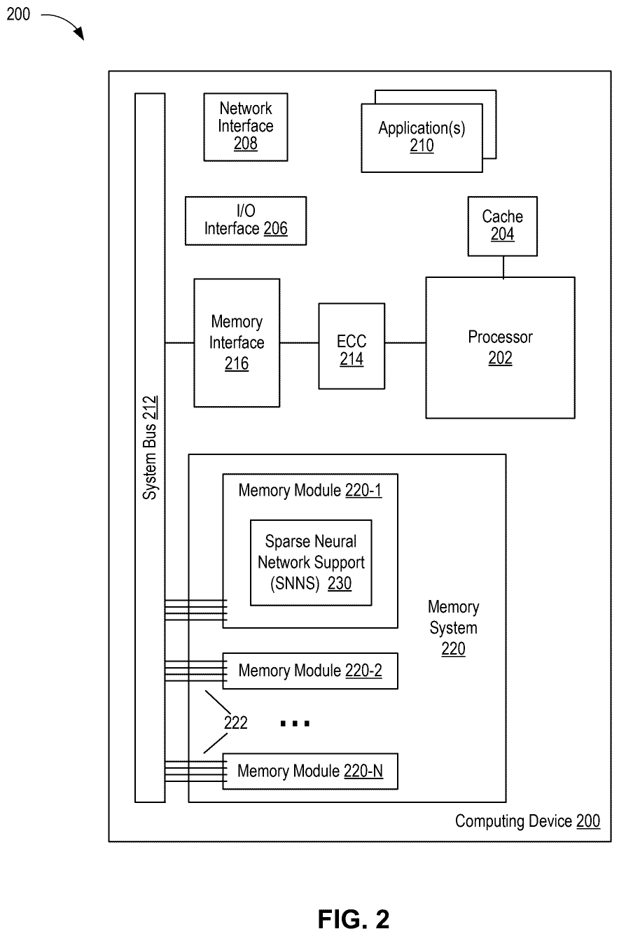

FIG. 2 is a block diagram illustrating an example computing device 200 in which implementations of the present disclosure may operate. Computing device 200 may be any desktop computer, a tablet, a smartphone, a server (local or remote), a thin/lean client device, a server, a cloud computing node, an edge device, a network switch, a gateway device, a card reader, a wireless sensor node, an Internet-of-Things (IoT) node, an embedded system dedicated to one or more specific applications, and so on. Computing device 200 may include one or more processors 202, e.g., central processing units (CPUs), graphics processing units (GPUs), field-programmable gate arrays (FPGA), application-specific integrated circuits (ASICs), and the like. “Processor” refers to a device capable of executing instructions encoding arithmetic, logical, or I/O operations. In one illustrative example, a processor may follow the von Neumann architectural model and may include one or more arithmetic logic units (ALUs), a control unit, and may further have access to a plurality of registers, or a cache 204.

Processor 202 may include one or more processor cores. In implementations, each processor core may execute instructions to run a number of hardware threads, also known as logical processors. Various logical processors (or processor cores) may be assigned to one or more processes supported by processor 202, although more than one processor core (or a logical processor) may be assigned to a single processor for parallel processing. A multi-core processor may simultaneously execute multiple instructions. A single-core processor may typically execute one instruction at a time (or process a single pipeline of instructions).

Computing device 200 may include one or more memory systems 220. The memory system 220 may refer to any volatile or non-volatile memory and may include a read-only memory (ROM), a random-access memory (RAM), electrically erasable programmable read-only memory (EEPROM), flash memory, flip-flop memory, or any other device capable of storing data. RAM may be a dynamic random-access memory (DRAM), synchronous DRAM (SDRAM), a static memory, such as static random-access memory (SRAM), and the like. In some implementations, processor(s) 202 and memory system 220 may be implemented as a single controller, e.g., as an FPGA. In some implementations, memory system 220 may be or include a DIMM (Dual In-Line Memory Module) system. In some implementations, memory system 220 may include Compute Express Link (CXL®) buffer chips, High Bandwidth Memory (HBM) chips, and/or other memory devices.

Memory system 220 may include multiple memory modules 220-1 . . . 220-N. In some implementations, memory modules 220-1 . . . 220-N may be accessed via memory channels 222. In some implementations, memory channels 222 may support simultaneous write (store) and read (load) operations, e.g., simultaneous storing and/or reading of data, e.g., weights, biases, various index data for the weights/biases, and/or the like.

Computing device 200 may further include an input/output (I/O) interface 206 to facilitate connection of the computing device 200 to various peripheral hardware devices (not shown in FIG. 2) such as card readers, terminals, printers, scanners, IoT devices, and the like. Computing device 200 may further include a network interface 208 to facilitate connection to a variety of networks (Internet, wireless local area networks (WLAN), personal area networks (PAN), public networks, private networks, etc.), and may include a radio front end module and other devices (amplifiers, digital-to-analog and analog-to-digital converters, dedicated logic units, etc.) to implement data transfer to/from computing device 200. Various hardware components of the computing device 200 may be connected via a system bus 212 that may include its own logic circuits, e.g., a bus interface logic unit (not shown in FIG. 2).

Computing device 200 may support one or more applications 210. Application(s) 210 supported by computing device 200 may include machine-learning application(s), graphics application(s), computational application(s), cryptographic application(s) (such as authentication, encryption, decryption, secure storage application(s), etc.), embedded application(s), external application(s), or any other types of application(s) that may be executed by computing device 200. Application(s) 210 may be instantiated on the same computing device 200, e.g., by an operating system executed by the processor 202 and residing in the memory system 220. Alternatively, the external application(s) may be instantiated by a guest operating system supported by a virtual machine monitor (hypervisor) operating on the computing device 200. In some implementations, the external application(s) may reside on a remote access client device or a remote server (not shown), with the computing device 200 providing computational support for the client device and/or the remote server.

Computing device 200 may include an error correction circuit (ECC) 214 that may receive, from processor 202, a data message to be stored in memory system 220 or transmitted over network interface 208. ECC 214 may include an error correction encoder that generates a codeword encoding the data and including one or more parity symbols and may further include an error correction decoder to perform inverse operations of decoding codewords retrieved from memory system 220 or received via network interface 208.

Data generated by processor 202 and processed by ECC 214 may be provided to a memory interface 216, which may include a clock signal generator to generate timed signals and a driver circuit to drive the timed signals to memory system 220 (e.g., one or more memory modules 220-1 . . . 220-N).

A memory module 220-j may include a sparse NN support 230 which may include a controller or any suitable circuitry capable of implementing indexing, dereferencing, storage and retrieval of parameters of sparse NNs in memory system 220. For brevity and conciseness, SNNS 230 is shown in FIG. 2 in conjunction with memory module 220-1 but any, some or all of memory chips 220-1 . . . 220-N of memory system 220 may also include SNNS 230 or a similar circuitry.

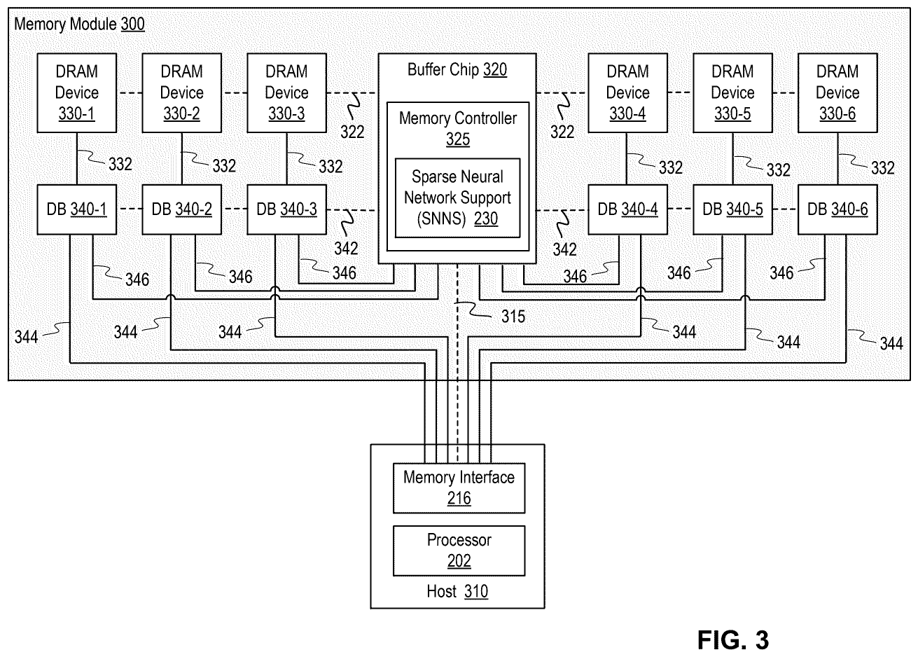

FIG. 3 illustrates an architecture of a memory module 300 having a sparse neural network support, in accordance with some aspects of the present disclosure. In some implementations, memory module 300 may be one of memory modules 220-j of FIG. 2. As shown in FIG. 3, memory module 300 may communicate with a host 310 (e.g., computing device 200 of FIG. 2 or part of computing device 200), which may include a processor 202 and memory interface 216 but may also include multiple other components disclosed in relation to FIG. 2, e.g., cache 204, ECC 214, and/or the like. In one implementation, memory module 300 may be, or include, is a dual in-line memory module (DIMM). Such memory modules can be referred to as DRAM DIMMs or load reduced DIMMs (LRDIMMs), or as a Compression Attach Memory Module (CAMM), and can share a memory channel with other DIMMs.

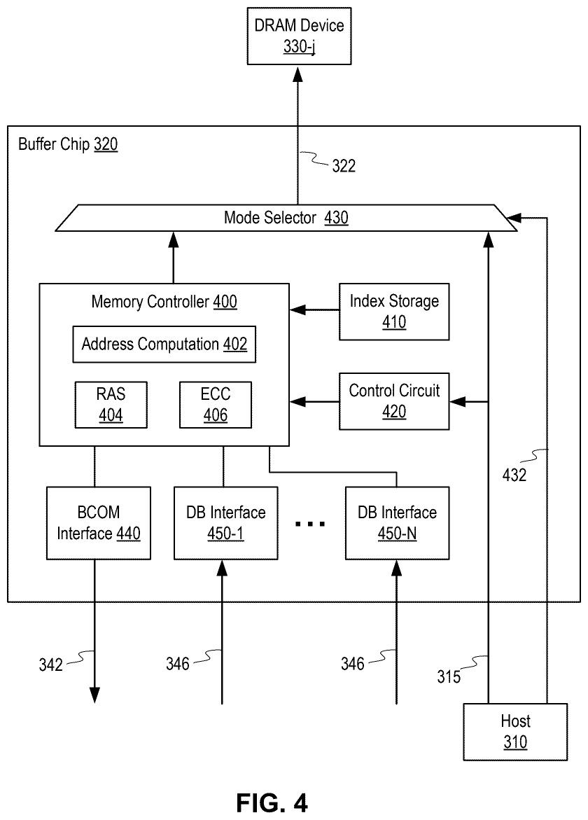

Memory module may include a buffer chip 320 that receives, via a communication bus 315, write and read commands from host 310 and communicates the received commands to DRAM devices 330-j. Although six DRAM devices 330-1 . . . 330-6 are illustrated in FIG. 3 as an example, it should be understood that the number of DRAM devices 330-j need not be limited. In some implementations, buffer chip 320 may include a memory controller 325 with SNNS 230 that implements efficient tracking and retrieval (or storage) of non-zero values of sparse weight matrices of NNs, e.g., as disclosed in more detail in conjunction with FIGS. 4-9.

An individual DRAM device 330-j may include an array of memory units, e.g., SDRAM units, arranged in various topologies (e.g., A/B sides, single-rank, dual-rank, quad-rank, etc.) In some implementations, buffer chip 320 may include a registered clock driver (RCD) circuit that mediates signals between host 310 and DRAM devices 330-j, e.g., such as an RCD included in registered DIMMs (e.g., RDIMMs, LRDIMMs, MRDIMMs, etc.). For example, buffer chip 320 may keep data signals received from host 310 for a certain number of clock cycles (e.g., one) before transferring the received signals to DRAM devices 330-j, e.g. on the rising edge of the next clock signal. Various DRAM devices 330-j may be connected to buffer chip 320 by command bus 322 that communicates instructions (commands) from buffer chip 320. Command bus 322 may be a command and address (CA) bus, in some implementations. (Command buses, including communication bus 315 are indicated with dashed lines in FIG. 3.) In one example, commands may include read commands to fetch data (specified in the read commands) from one or more memory addresses in DRAM devices 330-j. In another example, commands may include write commands to store data into from one or more memory addresses in DRAM devices 330-j.

In some implementations, data fetched from DRAM devices 330-j may be delivered over data bus 332 to one or more data buffers (DBs) 340-j. Although six DBs 340-1 . . . 340-6 are illustrated in FIG. 3 as an example, it should be understood that the number of DBs 340-j need not be limited. An individual DB 340-j may collect (e.g., over one or more clock cycles) data fetched by one or more DRAM devices 330-j and generate a signal that drives collected data to host 310 over external data bus 344.

In some implementations, DBs 340-j may serve to redrive signals (e.g., data signals and/or data Q signals, etc.) or to combine the signals on external data bus 344 to help mitigate high electrical loads of large computing and/or memory systems. For example, each DB 340-j may include a signal transmitter circuit to transmit the signals.

DBs 340-j may be connected to buffer chip 320 by DB command bus 342, e.g., a CA bus. Commands communicated to DBs 340-j over DB command bus 342 may include instructions to DBs 340-j to receive data from DRAM devices 330-j and to communicate received data to host 310 (as part of read operations) or to receive data from host 310 and communicate the data to DRAM devices 330-j (as part of write operations).

In some implementations, data residing in DBs 340-j may also be delivered to buffer chip 320 over an internal data bus 346. For example, during a backward pass, SNNS 230 may request row indices 114 that may be delivered over data bus 332 and stored in one or more DBs 340-j for subsequent delivery to processor 202 of host 310. Additionally, row indices 114 may be provided over internal data bus 346 to buffer chip 320 where SNNS 230 may generate a new request for the weights identified by row indices 114. After the weights are added to the DBs 340-j, the DBs 340-j may deliver the data (e.g., row indices and weights) to host 310, e.g., responsive to another command from buffer chip 320.

Buffer chip 320 may include a logical register and a phase-lock loop (PLL) to receive and re-drive commands and address input signals from host 310 to the DRAM devices 340-j to reduce overhead by isolating the DRAM devices 340-j from host 310. In some implementations, individual DRAM devices 330-j may be configured with a default burst length representing an amount of data (e.g., in words) that may be transferred over data bus 332 in a single burst during a memory access operation. In addition, the input/output (I/O) width of data bus 332, which determines the number of bits that can be used for each data word transfer, may be a non-integer power of two. For example, the I/O width may be 12 in one embodiment, rather than 2, 4, 8, 16, etc. Given the I/O width of the data bus 332, in order to transfer an individual chunk of data (e.g., in response to a request from buffer chip 320, the requisite burst length to transfer the chunk of data may be misaligned with the default burst length of DRAM devices 330-j. In one embodiment, in order to reduce or eliminate bubbles in the data transferred on data bus 332, multiple data chunks can be grouped together to generate a gapless data burst.

The memory module 300 illustrated in FIG. 3 has merely one possible architecture. In other embodiments, in addition or in the alternative, memory module 300 may include other volatile memory devices, such as synchronous DRAM (SDRAM), Rambus DRAM (RDRAM), static random access memory (SRAM), and so on. The specific example shown where the buffer chip 320 and DRAM devices 330-j are separate components is intended as one possible embodiment. In another example, any or all of the components including the memory module 300 and/or other components may be implemented on a single system-on-chip (SoC) device or multiple devices in a single package or printed circuit board, multiple separate devices, and/or have other variations, modifications, and alternatives. In addition, memory module 300 may include additional and/or different components than those illustrated in FIG. 3. Furthermore, the illustrated components may be arranged differently depending on the embodiment.

FIG. 4 illustrates an example architecture of a buffer chip 320 capable of supporting indexing, dereferencing, and accessing parameters of sparse neural networks, in accordance with some aspects of the present disclosure. In some implementations, buffer chip 320 may include memory controller 400 that implements SNNS 230. Memory controller 400 may include address computation 402 to support identification of memory addresses where parameters of sparse NNs may be stored. Buffer chip 320 may include index storage 410 to store row offsets 102 and/or column offsets 112 for faster retrieval. Index storage 410 may be or include a cache, e.g., high-speed cache, registers, and/or the like. Buffer chip 320 may further include a control circuit 420 (or sequencer) configured to perform a sequence of memory retrieval operations in forward pass and backward pass operations of sparse NNs. Buffer chip 320 may also include a mode selector 430 capable of selecting between normal data read/write operations and sparse NN memory operations. In some implementations, mode selector 430 may include a multiplexer capable of receiving direct inputs from an external host via communication bus 315 and/or additional inputs generated by memory controller 400. Inputs from memory controller 400 may be processed in the instances of sparse NN operations. In some implementations, mode selector may select multiple modes for sparse NN operations, e.g., a first mode that does not use pointers, which may be a forward pass mode (although in some implementations, a mode that does not use pointers may be a backward pass model), or a second mode that uses pointers, which may be a backward pass mode (although in some implementations, a mode that does not use pointers may be a forward pass mode). A third mode may be used to process direct inputs from host 310, e.g., host-generated memory reads and/or writes that do not involve accessing (e.g., fetching or storing) parameters or sparse NNs. Selection between the modes may be performed using a control signal 432, which may be received from an external host, e.g. host 310. In some implementations, control signal 432 may be received from control circuit 420 of buffer chip 320 after control circuit 420 receives a configuration command from the host 310. Control signal 432 may be provided to mode selector 430 until a different configuration command is received by control circuit 420 from the host 310.

As illustrated in FIG. 4, memory controller 400 may be coupled to a buffer communication (BCOM) interface 440 that may be used to send commands (instructions) to various data buffers (e.g., DBs 340-j in FIG. 3) over DB command bus 342. For example, commands communicated to data buffers may include instructions to receive data from storage units (e.g., DRAM devices 330-j) or to forward data received from host 310 to the storage units.

Memory controller 400 may further include or couple to one or more DB interfaces 450-j connected to internal data bus 346. DB interfaces 450-j may be used to receive data from various DBs by memory controller 400 in those instances where additional memory retrieval or storage commands from memory controller 400 to DRAM devices 330-j may depend on the received data.

In some implementations, memory controller 400 may include an error correction circuit (ECC) 404 capable of correcting errors in data, e.g., using parity symbols stored together with the data. ECC 404 may be capable of correcting errors in the data provided that the number of incorrectly stored bits does not exceed the capacity of the error correction code. ECC 404 may be able to automatically correct many memory errors that happen due to transient hardware issues, such as power spikes, soft media errors, and so on. Memory controller 400 may further include a reliability, availability, and serviceability (RAS) module 406 to support error-handling of uncorrectable errors. For example, when an uncorrectable error is detected by RAS 406, a processor of host 310 may be informed of the error. The processor may then generate an interrupt signal (e.g., exception) informing an operating system of host 310 of the error. The operating system may then examine the uncorrectable memory error and implement a software recovery of the data.

In some implementations, BCOM interface 440 may support commands that indicate to DBs that the DBs are to send the data being requested to buffer chip 320 (rather than directly to a host as is the case in conventional data read operations), e.g., READ TO BUFFER CHIP or READ TO RCD, or any other suitable read command. Similarly, BCOM interface 440 may support commands that indicate to DBs that the DBs are to receive the data from buffer chip 320 (rather than from the host as is the case in conventional data write operations), e.g., WRITE TO BUFFER CHIP or WRITE TO RCD, or some other suitable write command.

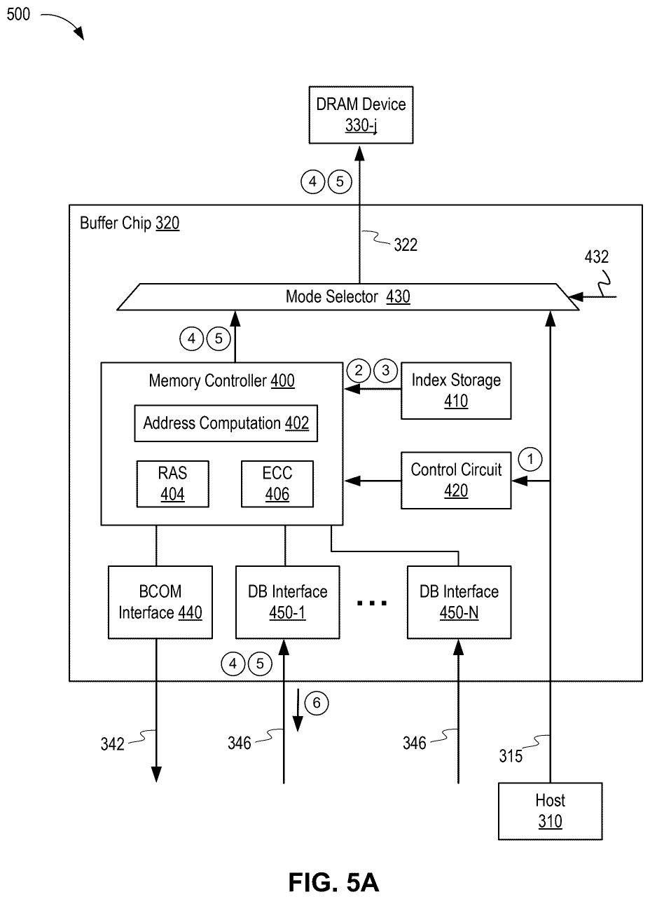

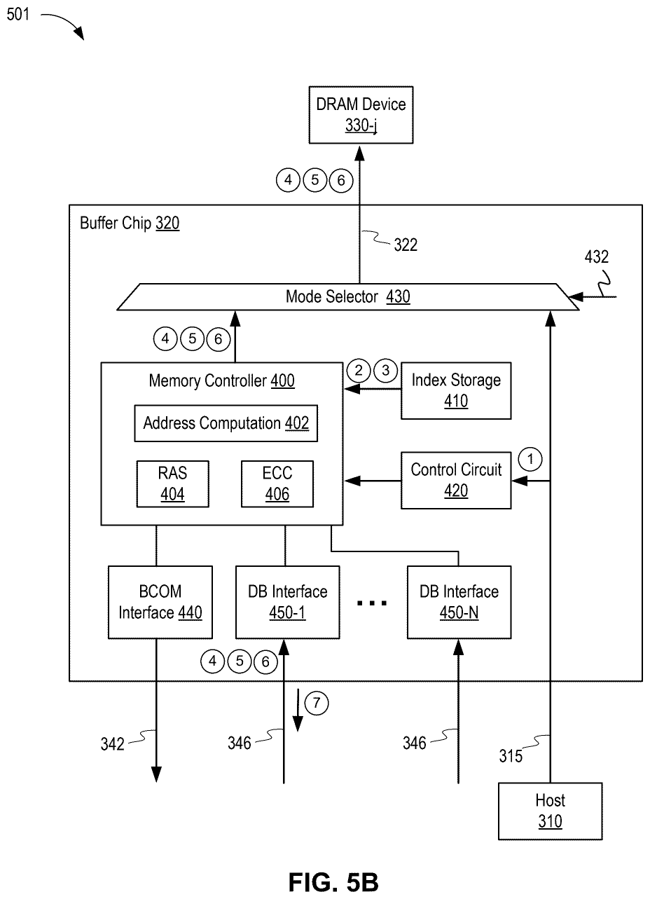

FIG. 5A illustrates an example data flow 500 implemented by the buffer chip of FIG. 4 as part of a forward pass of a sparse neural network, in accordance with some aspects of the present disclosure. Example data flow 500 may be triggered by a request (as indicated by the circled numeral 1 in FIG. 5A) communicated by host 310 to retrieve weights of neural edges connecting neurons of layer L to neurons of layer L+1 of a specific NN being executed (see FIG. 1A for an illustration). Buffer chip 320 may be operating under a forward-pass sparse NN mode selected by control signal 432 (e.g., provided by host 310 or control circuit 420). Memory controller 400 may retrieve, from index storage 410, row offsets (e.g., row offsets 102 with reference to FIG. 1B) associated with various rows, e.g., RowOffset[j] (indicated by the circled numeral 2 in FIG. 5A) and RowOffset[j+1] (indicated by the circled numeral 3 in FIG. 5A). Address computation 402 (which may be a dedicated hardware circuit) may then compute the differences between the retrieved row offsets, NumberElements[j]=RowOffset[j+1]−RowOffset[j], to determine the number of non-zero elements NumberElements[j] within row j of the sparse matrix of the NN. Such computations may be performed individually for consecutive rows j or as part of a batched processing for any, some, or all rows of the sparse weight matrix of a given layer. Memory controller 400 may then request, from one or more DRAM device 330-j, for various rows j of the sparse matrix the corresponding number of NumberElements[j] column indices and the same number NumberElements[j] of memory addresses (as indicated by the circled numeral 4 in FIG. 5A). Responsive to receiving such a request, DRAM device 330-j may provide, via a suitable DB and the corresponding DB interface 450-1, the requested column indices 104 (with reference to FIG. 1A) and memory addresses (e.g., memory addresses 108, with reference to FIG. 1A) to memory controller 400. After receiving the column indices and memory addresses stored in association with the column indices, memory controller 400 may request, from DRAM device 330-j (or some other DRAM device) values of matrix elements stored at the received memory addresses (as indicated by the circled numeral 5 in FIG. 5A). The requested values may also be received via DB interface 450-1 (or via some other DB interface 450-j). The received values may be combined with the previously received number of non-zero matrix elements NumberElements[j] and column indices for various rows and communicated to host 310 (as indicated by the circled numeral 6 in FIG. 5A).

The above operations are further illustrated with the following forward path pseudocode (the numerals in the pseudocode correspond to the circled numerals in in FIG. 5A):

```
for (top_acts=0;top_acts<a;top_acts++) {
1. row_index = Act[top_acts];
2. first = RowOffsets[row_index];
3. last = RowOffsets[row_index+1];
    num_weights = last − first;
    for (j=0;j<num_weights; j++) {element = first+j;
      4. col_index = ColumnIndices[element];
      5. weight_value = Values[element];
      6. return(row_index,col_index,weight_value);
      }
  }
```

FIG. 5B illustrates an example data flow 501 implemented by the buffer chip of FIG. 4 as part of a backward pass of a sparse neural network, in accordance with some aspects of the present disclosure. Example data flow 501 may be triggered by a request (as indicated by the circled numeral 1 in FIG. 5B) communicated by host 310 to retrieve weights of neural edges connecting neurons of layer L+1 to neurons of layer L of a particular NN being executed. Buffer chip 320 may be operating under a backward-pass sparse NN mode selected by control signal 432 (e.g., provided by host 310 or control circuit 420). Memory controller 400 may retrieve, from index storage 410, column offsets (e.g., column offsets 112 with reference to FIG. 1C) associated with various columns, e.g., ColumnOffset[k] (indicated by the circled numeral 2 in FIG. 5B) and ColumnOffset[k+1] (indicated by the circled numeral 3 in FIG. 5B). Address computation 402 may compute the differences between the retrieved column offsets, NumberElements[k]=ColumnOffset[k+1]−ColumnOffset[k], to determine the number of non-zero elements NumberElements[k] within column k of the sparse matrix of the NN. Such computations may be performed individually for consecutive columns k or as part of a batched processing for any, some, or all columns of the sparse weight matrix of a given layer. Memory controller 400 may then request, from a DRAM device 330-j, for various columns k of the sparse matrix the corresponding number NumberWeights[k] of row indices and the same number NumberElements[j] of pointers (as indicated by the circled numeral 4 in FIG. 5B). Responsive to receiving such a request, DRAM device 330-j may provide, via a suitable DB and the corresponding DB interface 450-1, the requested row indices (e.g., row indices 114, with reference to FIG. 1C) and pointers (e.g., pointers 116, with reference to FIG. 1C). After receiving the row indices and the pointers stored in association with the row indices, memory controller 400 may request, from DRAM device 330-j (or some other DRAM device) memory addresses identified by the received pointers (as indicated by the circled numeral 5 in FIG. 5B). The requested memory addresses may also be received via DB interface 450-1 (or via some other DB interface 450-j). Memory controller 400 may then dereference pointers by requesting, from DRAM device 330-j (or some other DRAM device) values of matrix elements stored at the received memory addresses referenced in the respective pointers (as indicated by the circled numeral 6 in FIG. 5B). The requested weights may also be received via DB interface 450-1 (or via some other DB interface 450-j). The received weights may be combined with the previously received number of non-zero matrix elements NumberElements[j] and row indices for various rows and communicated to host 310 (as indicated by the circled numeral 7 in FIG. 5B).

The above operations are further illustrated with the following backward path pseudocode (the numerals in the pseudocode correspond to the circled numerals in in FIG. 5B):

```
for (top_acts=0;top_acts<a;top_acts++) {
1. col_index = Act[top_acts];
2. first = ColumnOffsets[col_index];
3. last = ColumnOffsets[col_index+1];
    num_weights = last − first;
    for (k=0;k<num_weights; j++) {element = first+j;
      4. row_index = RowIndices.val[element];
      5. weight_addr = RowIndices.pointers[element];
      6. weight_value = *(weight_addr);
      7. return(row_index,col_index,weight_value);
      }
  }
```

In both the forward pass and the backward pass examples, data returned to the host 310, e.g., “row_index, col_index, weight_value,” may include various non-zero elements wⱼₖ of the sparse weight matrix, each element associated with a row index (“row_index”) j, column index (“col_index”) k, and the value of the element (“weight_value”) wⱼₖ.

FIG. 4 and FIGS. 5A-5B illustrate architecture and operations of a buffer chip that provides weights wⱼₖ to host 310 via one or more data buffers using data interface(s), e.g., DB interface 450-1.

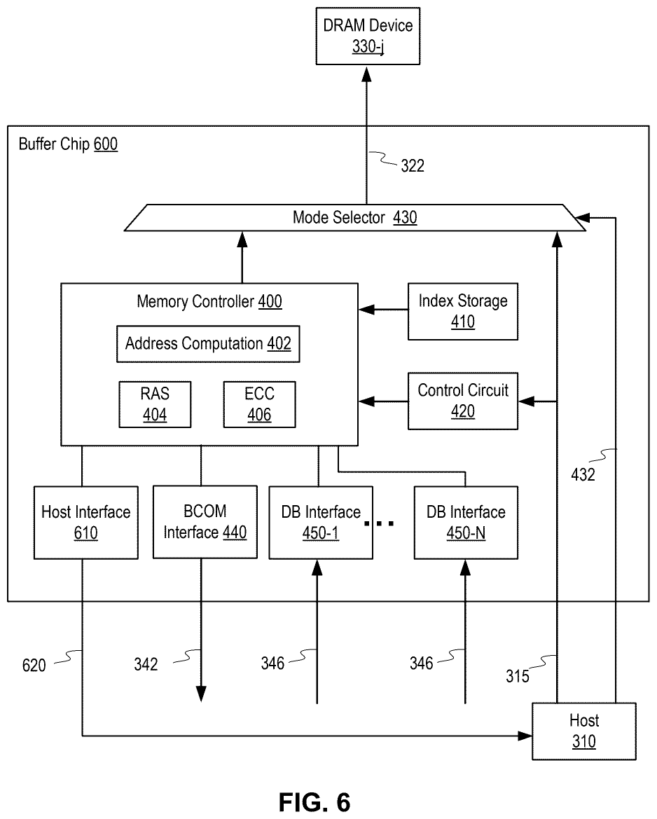

FIG. 6 illustrates another example architecture of a buffer chip 600 capable of supporting indexing, dereferencing, and accessing parameters of sparse neural networks, in accordance with some aspects of the present disclosure. Buffer chip 600 has an additional host interface 610 and a communication bus 620 (which may be combined with communication bus 315, in some implementations). Host interface 610 may be used to deliver matrix elements wⱼₖ to host 310 directly without using one or more data buffers as an intermediary.

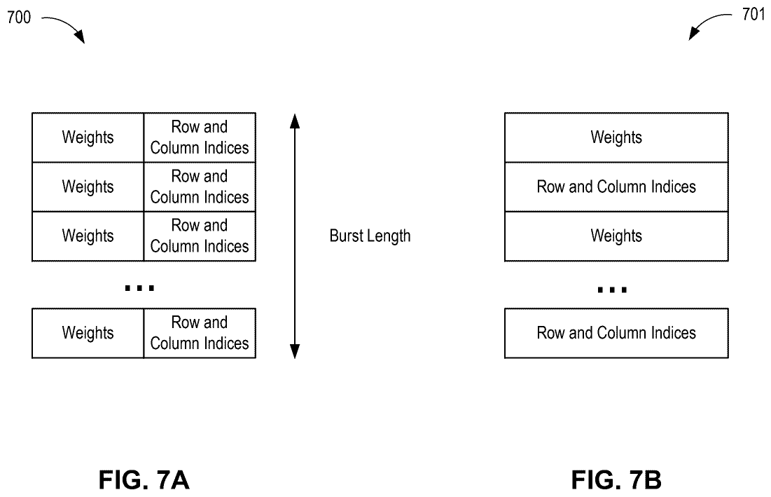

FIGS. 7A-7B illustrate schematically possible formats of data bursts delivered from the memory system to the host, in accordance with some aspects of the present disclosure. FIG. 7A illustrates a format 700 where weights (values of matrix elements) are sent together with the corresponding row and column indices. FIG. 7B illustrates another format 701 where weights are interleaved with row and column indices, e.g., with groups of multiple weights interleaved with groups of corresponding row and column indices.

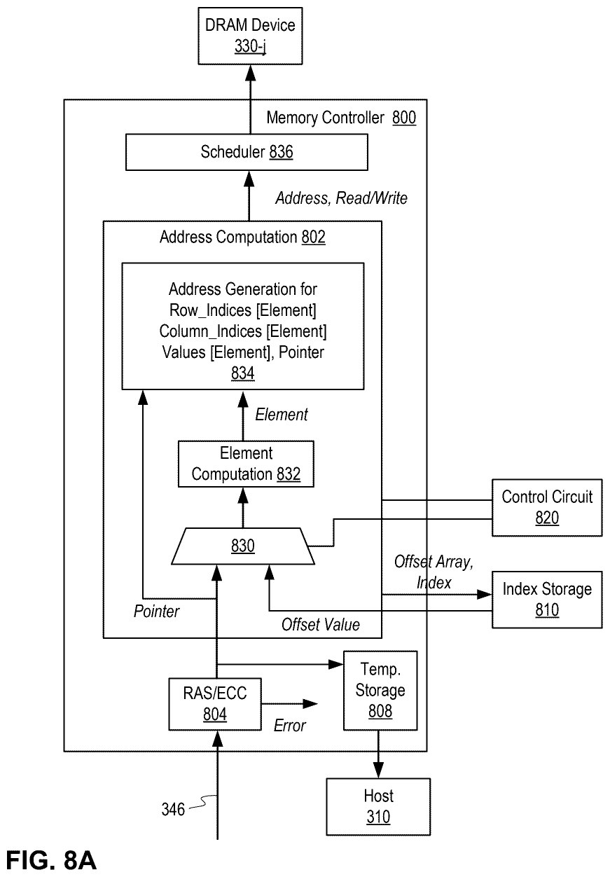

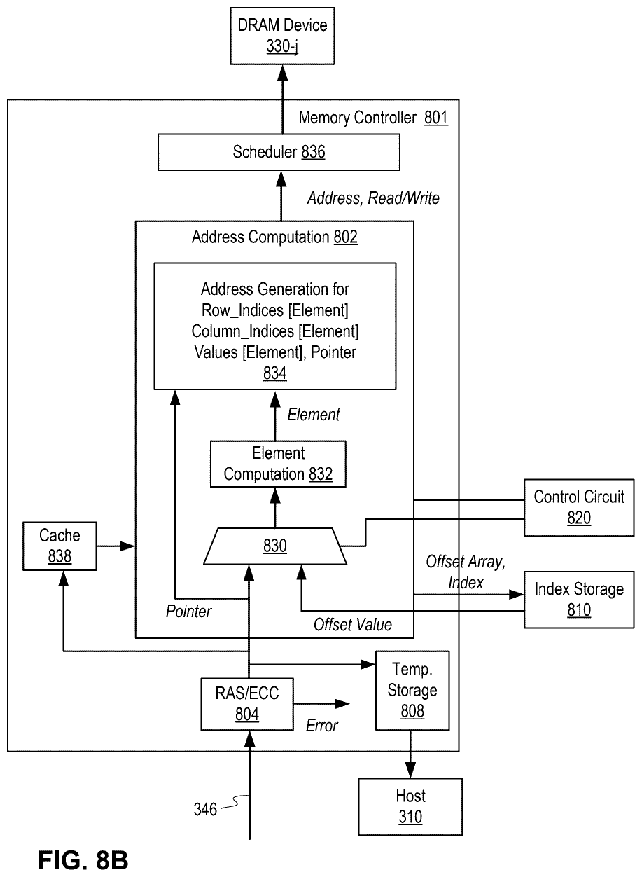

FIG. 8A illustrates an example architecture of a memory controller 800 deployed as part of a buffer chip that supports indexing, dereferencing, and accessing parameters of sparse neural networks, in accordance with some aspects of the present disclosure. In some implementations, memory controller 800 may be memory controller 400 of buffer chip 320 illustrated in FIGS. 4-5 and/or buffer chip 600 of FIG. 6. Memory controller 800 may include address computation 802 that determines addresses of various stored values in DRAM devices 330-j and a scheduler 836 that generates, formats, and schedules retrieval of those values from the DRAM devices. Inputs into memory controller 800 may come from index storage 810 (and may include row offsets and/or column offsets) and/or DRAM devices/DBs, e.g., over internal data bus 346 (and may include column indices, row indices, weight addresses, pointer to weight addresses, and/or the like). In some implementations, column indices, row indices, and/or other data may also be stored in index storage 810 for faster retrieval. Data received over internal data bus may undergo error correction/handling by RAS/ECC 804. In those instances where the received data is intended for delivery to host 310, the data may be stored in a temporary storage 808, which may be any suitable buffer or register. Multiplexer 830 may select, responsive to a control signal outputted by control circuit 820, an input into element computation 832 between column/row offsets (provided by index storage 810) and other data delivered from DRAM devices/DBs over internal data bus 346. Element computation 832 identifies elements wⱼₖ of a sparse matrix to be retrieved, and address generation 834 calculates addresses storing the values of those elements wⱼₖ using row indices, column indices, arrays of memory addresses, pointers to the arrays of memory addresses, and/or the like.

FIG. 8B illustrates another example architecture of a memory controller 801 deployed as part of a buffer chip that supports indexing, dereferencing, and accessing parameters of sparse neural networks, in accordance with some aspects of the present disclosure. Memory controller 801 may include cache 838 to hold a portion of data received over the internal data bus 346. For example, data fetched from the DRAM devices may have a minimum chunk size, e.g., 64 bytes or some other size, which may exceed the size of data (e.g., column/row indices, array of the memory addresses, pointers) that address computation 802 needs to obtain addresses where specific elements of the sparse matrix are stored. In such instances, cache 838 may store a spillover data related to additional matrix elements (e.g., subsequent elements). To save time and processing resources during subsequent clock cycles, address computation 802 may first check whether cache 838 already stores data for the elements being retrieved and skip fetching this data again from the DRAM device(s).

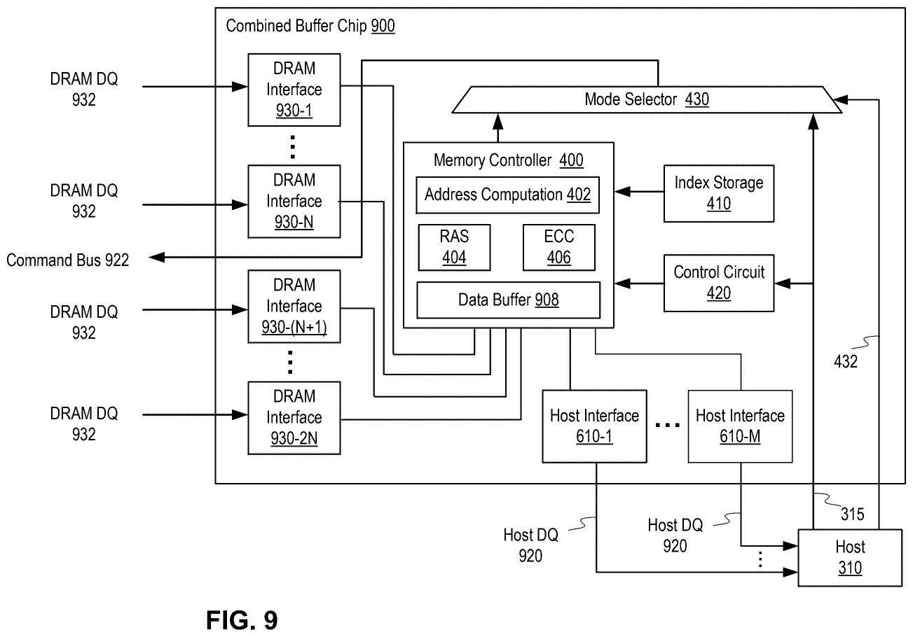

FIG. 9 illustrates an example architecture of a combined buffer chip 900 capable of supporting indexing, dereferencing, and accessing parameters of sparse neural networks, in accordance with some aspects of the present disclosure. Combined buffer chip 900 performs a double function of a buffer chip (e.g., buffer chip 320 of FIG. 3 or buffer chip 600 of FIG. 6) and data buffers (e.g., DBs 340-j of FIG. 3). As illustrated in FIG. 9, buffer chip 900 may use command bus 922 to communicate read instructions to various DRAM devices (not shown in FIG. 9) and receive, at one or more DRAM interfaces 930-1 . . . 930-2N via data bus 932 (e.g., DRAM DQ bus), requested data from the DRAM devices. The received data, e.g., column indices, row indices, matrix element values, may be collected in a data buffer 908 of memory controller 400 prior to streaming the collected data to host 310 via one or more host interfaces 610-1 . . . 610-M, e.g., over external data bus 920 (e.g., host DQ bus). Write operations may be performed in the opposite order, e.g., with data to be stored received from host 310 over external data bus 920 and placed in data buffer 908 of memory controller 400 before being driven to the DRAM devices via data bus 932 and one or more DRAM interfaces 930-1 . . . 930-2N.

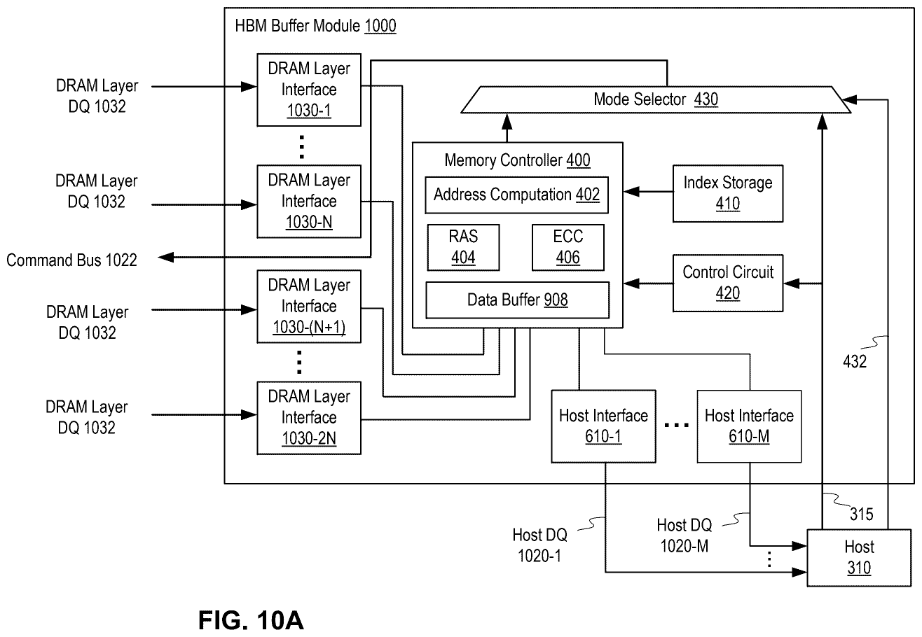

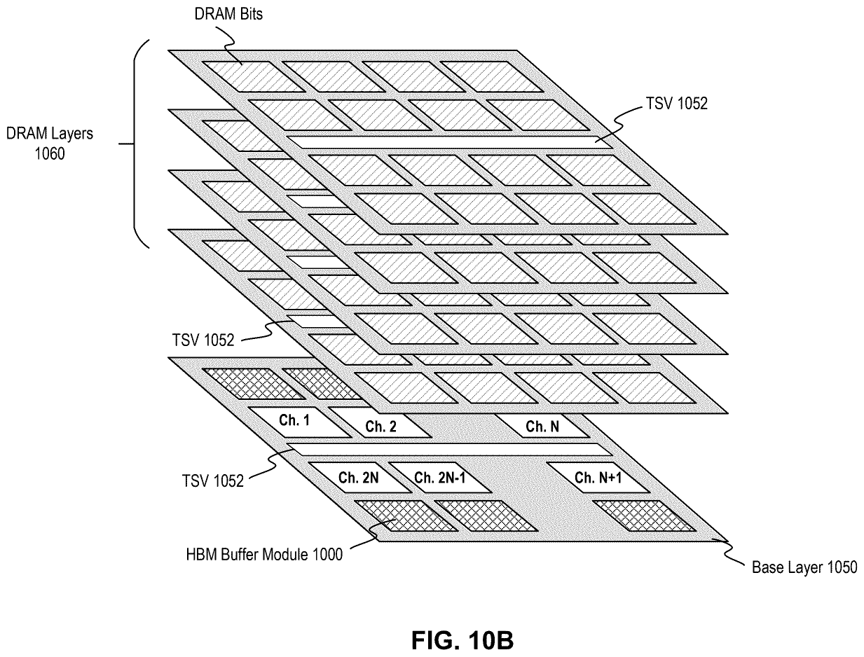

FIGS. 10A-10B illustrate an example architecture of a high bandwidth (HBM) memory system capable of supporting indexing, dereferencing, and accessing parameters of sparse neural networks, in accordance with some aspects of the present disclosure. As illustrated in FIG. 10A, an HBM buffer module 1000, which implements functionality similar to that of buffer chip 320 of FIGS. 3-5, may be integrated into the base die and may use command bus 1022 to communicate instructions to various DRAM layers and data to the various DRAM layers using data bus 1032 (e.g., DRAM Layer DQ bus) and one or more DRAM layer interfaces 1030-1 . . . 1030-2N. As illustrated in FIG. 10B, individual DRAM layers 1060 are connected by through-silicon via (TSV) 1052 to a base layer 1050 having multiple channels (Ch. 1, Ch. 2 . . . . Ch. 2N) with each channel supported by an individual HBM buffer module 1000. Data, e.g., row and column indices, may be stored in the base layer 1050, e.g., in HBM buffer module 1000, before being sent to host 310 over one or more host DQ buses 1020-1 . . . 1020-M.

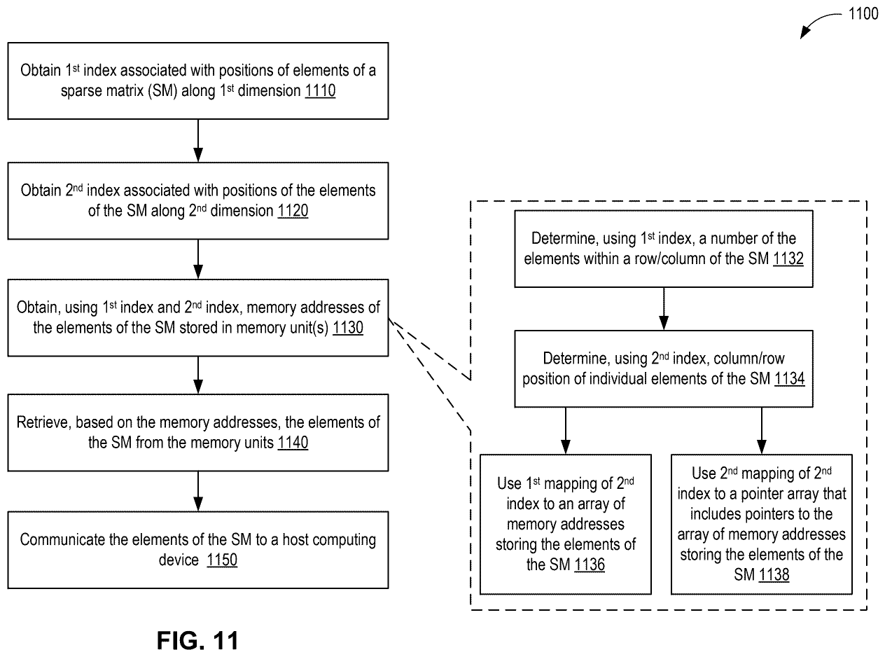

FIG. 11 is a flow diagram illustrating an example method 1100 of retrieving elements of sparse matrices stored in a memory module, in accordance with some aspects of the present disclosure. In some implementations, sparse matrices whose elements are retrieved (fetched, read, etc.) may correspond to matrices of weights of various layers of neural networks. In some implementations, a memory module performing method 1100 may include a memory module 220-j of FIG. 2, a memory module 300 of FIG. 3, and/or some other suitable memory device. The memory module performing method 1100 may include one or more memory units, e.g., DRAM devices 330-j (with reference to FIG. 3), but may also include one or more HBM memory units, CXL memory units, or memory units of other types. The memory module performing method 1100 may further include a buffer chip having a processing circuitry that executes various operation of the method, e.g., buffer chip 320 of FIG. 3-5, buffer chip 600 of FIG. 6, or HBM buffer module 1000 of FIG. 10.

In some implementations, various blocks of method 1100 may be performed in a different order compared with the order shown in FIG. 11. Some blocks may be performed concurrently with other blocks. Some blocks may be optional. In certain implementations, a single processing thread may perform method 1100. Alternatively, two or more processing threads may perform method 1100, each thread executing one or more individual functions, routines, subroutines, or operations of the methods. In an illustrative example, the processing threads implementing method 1100 may be synchronized (e.g., using semaphores, critical sections, and/or other thread synchronization mechanisms). Alternatively, the processing threads implementing method 1100 may be executed asynchronously with respect to each other. Various operations of method 1100 may be performed in a different order compared with the order shown in FIG. 11. Some operations of method 1100 may be performed concurrently with other operations. Some operations may be optional.

In some implementations, the buffer chip may be configurable into a plurality of modes. In a first mode, the buffer chip may retrieve the plurality of the elements of a sparse matrix (SM) in a row-wise order, e.g., row by row, using compressed sparse row format (as illustrated in FIG. 1B). In a second mode, the buffer chip may retrieve the plurality of the elements of the SM in a column-wise order, e.g., column by column using compressed sparse column format (as illustrated in FIG. 1C).

At block 1110, a buffer chip of a memory module performing method 1100 may obtain a first index associated with positions of a plurality of elements of the SM along a first dimension of the SM. For example, in the first mode, the first index may include row offsets 102 (with reference to FIGS. 1A-C). In the second mode, the first index may include column offsets 112.

At block 1120, the buffer chip may obtain a second index associated with positions of the plurality of the elements of the SM along a second dimension of the SM. For example, in the first mode, the second index may include column indices 104. In the second mode, the second index may include row indices 114. In some implementations, the first index and/or the second index may be obtained from a cache of the buffer chip (e.g., index storage 410 of FIG. 4). In some implementations, the second index may be obtained from the one or more memory units (e.g., DRAM devices 330-j).

At block 1130, the buffer chip may obtain, using the first index and the second index, memory addresses of the plurality of the elements of the SM stored in the one or more memory units. In some implementations, obtaining the memory addresses (e.g., memory addresses 108) may include operations of the callout portion of FIG. 11. More specifically, at block 1132, the buffer chip may determine, using the first index, a number of the elements of the SM within an individual row of the SM (e.g., when the first mode is used) or an individual column of the SM (e.g., when the second mode is used). For example, using row offsets 102, the buffer chip may determine that row 0 has two elements, row 1 has one element, row 2 has no elements, row 3 has two elements, and so on.

At block 1134, the buffer chip may determine, using the second index, for each of the number of the elements of the SM, a column position of an individual element of the SM (e.g., when in the first mode) or a row position of the individual element of the SM (e.g., hen in the second mode). For example, using column indices 104, the buffer chip may determine that the two elements of row 0 are in column positions 0 and 2, the one element of row 1 is in column position 1, the three elements of row 4 are in column positions 1, 2, and 3, and so on.

As further illustrated with the callout portion of FIG. 11, operations of block 1130 may depend on the selected mode of the buffer chip operations. As illustrated with block 1136, when the first mode is selected, the buffer chip may use a first mapping of the second index to an array of memory addresses storing the plurality of elements of the SM. For example, the first mapping may include mapping of column indices 104 to memory addresses 108, as indicated with the dashed arrows. The first mapping may be a one-to-one correspondence between column indices 104 to memory addresses 108. In some implementations, column indices 104 may be stored in association with memory addresses 108, e.g., at the same or adjacent memory addresses. For example, a second cell “2” of the column indices 104 in FIG. 1B may be mapped to the memory address “1” storing value “B.”

As illustrated with block 1138, when the second mode is selected, the buffer chip may use a second mapping of the second index to a pointer array (e.g., pointers 116) that includes pointers to the array of memory addresses (e.g., memory addresses 108) storing the plurality of elements of the SM. For example, the second mapping may include mapping of row indices 114 to pointers 116, e.g., a one-to-one correspondence between row indices 114 and pointers 116, with pointers 116 storing memory addresses where actual matrix element values are stored. For example, a fourth cell “3” of the row indices 114 in FIG. 1C may be mapped to a pointer to the memory address “3” storing value “D.” In some implementations, operations of block 1138 may involve the buffer chip dereferencing the pointer array.

At block 1140, method 1100 may include retrieving, based on the memory addresses, the plurality of the elements of the SM from the one or more memory units. At block 1150, method 1100 may continue with communicating, to a host computing device the retrieved plurality of the elements of the SM.

In some implementations, operations of method 1100 may be supported by one or more data buffers (e.g., DBs 340-j in FIG. 3) that receive the plurality of the elements of the SM from the one or more memory units. In some implementations, operations of method 1100 may be further supported by one or more data interfaces (e.g., DB interfaces 450-j in FIG. 4). The one or more data buffers may receive the second index, the memory addresses of the plurality of the elements of the SM, and/or the plurality of the elements of the SM.

In some implementations, operations of method 1100 may be supported by a command interface (e.g., BCOM interface 440 in FIG. 4) that communicates instructions to the one or more memory units to provide, to the one or more data buffers, the second index, the memory addresses of the plurality of the elements of the SM, and/or the plurality of the elements of the SM.

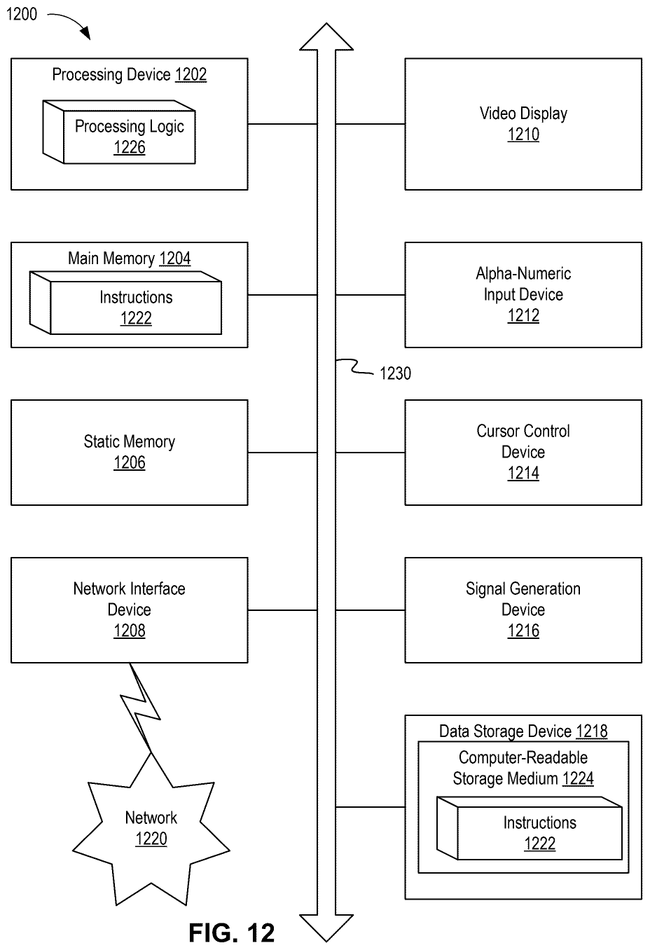

FIG. 12 depicts an example computer system 1200 capable of deploying systems and techniques in accordance with some aspects of the present disclosure. The example, computer system 1200 may include computing device 200 of FIG. 2, host 310, memory module 300 of FIG. 3, and/or other systems 1200 and components disclosed in conjunction with FIGS. 4-10. The example computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a Personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The exemplary computer system 1200 includes a processing device 1202, a main memory 1204 (e.g., read-only memory (ROM), flash memory, dynamic random access memory (DRAM) such as synchronous DRAM (SDRAM)), a static memory 1206 (e.g., flash memory, static random access memory (SRAM)), and a data storage device 1218, which communicate with each other via a bus 1230.

Processing device 1202 (which can include processing logic 1226) represents one or more general-purpose processing devices such as a microprocessor, central processing unit, or the like. More particularly, the processing device 1202 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1202 may also be one or more special-purpose processing devices such as an application specific integrated circuit (ASIC), a field programmable gate array (FPGA), a digital signal processor (DSP), network processor, or the like. The processing device 1202 is configured to execute instructions 1222 for implementing various techniques disclosed herein (e.g., method 1100 of FIG. 1100).

The computer system 1200 may further include a network interface device 1208 to facilitate connection of computer system 1200 to network 1220. The computer system 1200 also may include a video display unit 1210 (e.g., a liquid crystal display (LCD) or a cathode ray tube (CRT)), an alphanumeric input device 1212 (e.g., a keyboard), a cursor control device 1214 (e.g., a mouse), and a signal generation device 1216 (e.g., a speaker). In one illustrative example, the video display unit 1210, the alphanumeric input device 1212, and the cursor control device 1214 may be combined into a single component or device (e.g., an LCD touch screen).

The data storage device 1218 may include a computer-readable storage medium 1224 on which is stored the instructions 1222 embodying any one or more of the methodologies or functions described herein. The instructions 1222 may also reside, completely or at least partially, within the main memory 1204 and/or within the processing device 1202 during execution thereof by the computer system 1200, the main memory 1204 and the processing device 1202 also constituting computer-readable media. In some implementations, the instructions 1222 may further be transmitted or received over a network via the network interface device 1208.

While the computer-readable storage medium 1224 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “analyzing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each operatively coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation unless described as such. Furthermore, the terms “first,” “second,” “third,” “fourth,” etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

What is claimed is:

1. A memory module comprising:
one or more memory units; and
a buffer chip communicatively coupled to the one or more memory units, the buffer chip comprising a memory controller to:
obtain a first index associated with positions of a plurality of elements of a sparse matrix (SM) along a first dimension of the SM;
obtain a second index associated with positions of the plurality of the elements of the SM along a second dimension of the SM;
obtain, using the first index and the second index, memory addresses of the plurality of the elements of the SM stored in the one or more memory units; and
retrieve, based on the memory addresses, the plurality of the elements of the SM from the one or more memory units.

2. The memory module of claim 1, wherein at least one of the first index or the second index is obtained from a cache of the buffer chip.

3. The memory module of claim 1, wherein the second index is obtained from the one or more memory units.

4. The memory module of claim 1, wherein to obtain the memory addresses of the plurality of the elements of the SM, the memory controller is to:
determine, using the first index, a number of the elements of the SM within at least one of:
an individual row of the SM, or
an individual column of the SM.

5. The memory module of claim 4, wherein to obtain the memory addresses of the plurality of the elements of the SM, the memory controller is further to:
determine, using the second index, for each of the number of the elements of the SM, at least one of:
a column position of an individual element of the SM, or
a row position of the individual element of the SM.

6. The memory module of claim 1, wherein to obtain the memory addresses of the plurality of the elements of the SM, the memory controller is to use at least one of:
a first mapping of the second index to an array of memory addresses storing the plurality of elements of the SM, or
a second mapping of the second index to a pointer array comprising pointers to the array of memory addresses storing the plurality of elements of the SM.

7. The memory module of claim 6, wherein the buffer chip is configurable into a plurality of modes, the plurality of modes comprising at least a first mode and a second mode,
wherein in the first mode, the memory controller is to retrieve the plurality of the elements of the SM in a row-wise order,
wherein in the second mode, the memory controller is to retrieve the plurality of the elements of the SM in a column-wise order,
wherein the memory controller is to use the first mapping in one of the first mode or in the second mode, and
wherein the memory controller is to use the second mapping in another one of the first mode or the second mode.

8. The memory module of claim 1, wherein to obtain the memory addresses of the plurality of the elements of the SM, the memory controller is to:
dereference a pointer array comprising pointers to an array of memory addresses storing the plurality of elements of the SM, wherein the pointer array is mapped to the second index using a pre-determined mapping.

9. The memory module of claim 1, further comprising:
one or more data buffers to receive the plurality of the elements of the SM from the one or more memory units;
wherein the memory controller further comprises:
one or more data interfaces to receive, from the one or more data buffers, at least:
the second index,
the memory addresses of the plurality of the elements of the SM, or
the plurality of the elements of the SM.

10. The memory module of claim 9, wherein the buffer chip further comprises:
a command interface to communicate instructions to the one or more memory units to provide, to the one or more data buffers, at least one of:
the second index,
the memory addresses of the plurality of the elements of the SM, or
the plurality of the elements of the SM.

11. The memory module of claim 9, wherein the buffer chip further comprises:
a host interface to communicate the plurality of the elements of the SM to a host computing device.

12. The memory module of claim 1, wherein the one or more memory units comprise at least one of:
a dynamic random-access memory (DRAM) unit,
a compute express link (CXL) memory unit, or
a high bandwidth memory (HBM) memory unit.

13. A buffer chip to:
obtain, from a cache of the buffer chip, a first index associated with positions of a plurality of elements of a sparse matrix (SM) along a first dimension of the SM;
obtain, from one or more memory units, a second index associated with positions of the plurality of the elements of the SM along a second dimension of the SM;
obtain, using the first index and the second index, memory addresses of the plurality of the elements of the SM stored in the one or more memory units; and
retrieve, based on the memory addresses, the plurality of the elements of the SM from the one or more memory units.

14. The buffer chip of claim 13, wherein to obtain the memory addresses of the plurality of the elements of the SM, the buffer chip is to:
determine, using the first index, a number of the elements of the SM within at least one of:
an individual row of the SM, or
an individual column of the SM.

15. The buffer chip of claim 14, wherein to obtain the memory addresses of the plurality of the elements of the SM, the buffer chip is further to:
determine, using the second index, for each of the number of the elements of the SM, at least one of:
a column position of an individual element of the SM, or
a row position of the individual element of the SM.

16. A method comprising:
obtaining, using a buffer chip of a memory system, a first index associated with positions of a plurality of elements of a sparse matrix (SM) along a first dimension of the SM;
obtaining, using the buffer chip of the memory system, a second index associated with positions of the plurality of the elements of the SM along a second dimension of the SM;
processing, using the buffer chip of the memory system, the first index and the second index to obtain memory addresses of the plurality of the elements of the SM stored in one or more memory units; and
retrieving, based on the memory addresses, the plurality of the elements of the SM from the one or more memory units.

17. The method of claim 16, wherein processing the first index and the second index to obtain the memory addresses of the plurality of the elements of the SM comprises:
determining, using the first index, a number of the elements of the SM within at least one of:
an individual row of the SM, or
an individual column of the SM.

18. The method of claim 17, wherein processing the first index and the second index to obtain the memory addresses of the plurality of the elements of the SM further comprises:
determining, using the second index, for each of the number of the elements of the SM, at least one of:
a column position of an individual element of the SM, or
a row position of the individual element of the SM.

19. The method of claim 16, wherein processing the first index and the second index to obtain the memory addresses of the plurality of the elements of the SM comprises using at least one of:
a first mapping of the second index to an array of memory addresses storing the plurality of elements of the SM, or
a second mapping of the second index to a pointer array comprising pointers to the array of memory addresses storing the plurality of elements of the SM.

20. The method of claim 16, further comprising:
communicating, using a host interface of the buffer chip, the plurality of the elements of the SM to a host computing device.
